(19) United States
(12) Patent Application Publication
(10) Pub. No.: US 2005/0219221 A1
(43) Pub. Date: Oct. 6, 2005

(54) Remote control device

(75) Inventors: Kazunobu Ohkuri, Kanagawa (JP); Yoshio Ohashi, Kanagawa (JP); Masaru Uryu, Chiba (JP); Kunihiko Tokura, Tokyo (JP); Taro Nakagami, Kanagawa (JP); Toru Takebe, Tokyo (JP)

Correspondence Address: WOLF GREENFIELD & SACKS, PC;FEDERAL RESERVE PLAZA, 600 ATLANTIC AVENUE, BOSTON, MA, 02210-2211, US

(73) Assignee: Sony Corporation, Tokyo (JP)

(21) Appl. No.: 11/094,971

(22) Filed: Mar. 31, 2005

(30) Foreign Application Priority Data
Mar. 31, 2004 (JP) JP2004-104994

(51) Int. Cl. G09G 5/00

(52) U.S. Cl. 345/169

(57) ABSTRACT

A remote control device is configured so that a display direction of contents on a liquid crystal display section can be switched according to slide operation of a slide switch. The remote control device can prevent the display direction from being switched despite the intention of a user, thus more appropriately switching the display direction of contents displayed on the liquid crystal display section.

### BACKGROUND OF THE INVENTION

1. Field of the Invention

The present invention relates to remote control devices and is particularly suitable for remote controllers with display devices, for example.

2. Description of the Related Art

Many of portable electronic devices such as remote controllers of mobile audio players, digital cameras, and mobile phones include a display device consisting of a liquid crystal panel respectively.

For such portable electronic devices, a display direction of a character, an image or the like on the display device is determined so that a direction of the character, the image or the like may be proper when their users view a display screen from a prescribed direction. In other words, the users who view the display screen from any other direction than the prescribed direction are not presented the character or image in a proper direction.

Some of the portable electronic devices are so structured that a display direction of the character, the image or the like on the display screen may be switched.

As means for switching the display direction, for example, there is proposed one device that is provided with a remote controller of the mobile audio player including an acceleration sensor, which detects an inclination of the remote controller, to change the display direction according to the inclination, and is also proposed another device that is provided with a display screen pivotally supported on a casing of the digital camera through a hinged section to switch the display direction according to the pivoting operation of the display screen. (For example, see Japanese Patent Laid-Open No. 2001-272719).

### SUMMARY OF THE INVENTION

In old means, however, the display direction is sometimes switched despite the intention of a user because the display direction is automatically switched according to the detected result of the acceleration sensor or the pivoting operation of a pivotable display screen, so that there is a problem that the display direction of a character, an image or the like is not always switched in a proper direction when viewed from a user.

In view of the aforementioned problem, it is an object of the present invention to provide a remote control device which is capable of more appropriately switching a display direction of a displayed content.

To achieve the above-described object, a remote control device according to the present invention comprises a display means, a switching means for switching the display direction of contents displayed on the display means, and an operational means for remote-controlling a main unit. The display means switches a display direction of contents displayed according to the operation of the switching means.

An electronic device of the present invention comprises an operation device including a display means, a switching means for switching a display direction of contents on the display means and an operation means, and a control means for controlling the operation device. The operation means switches a display direction of contents on the display means according to the operation of the switching means.

By switching the display direction of contents on the display means according to the operation of the switching means, switching the display direction despite the intention of a user can be prevented.

According to the present invention, this remote control device comprises the display means, the switching means for switching the display direction of contents on the display means, and the operation means for remote-operating a main unit. The display direction of contents displaced by the display means is switched according to the operation of the switching means, and can be prevented from being switched despise the intention of a user. Thus, this remote control device can switches the display direction of the displaced contents more appropriately.

According to the present invention, this electronic device comprises the operation device including the display means, the switching means for switching the display direction of contents displayed on the display means and the operation means, and the control means for controlling the operation device. The display direction of contents displayed by the display means is switched according to the operation of the switching means, the control means prevents the display direction from being switched despise the intention of a user. The electronic device switches the display direction of the displaced contents more appropriately.

The nature, principle and utility of the invention will become more apparent from the following detailed description when read in conjunction with the accompanying drawings in which like parts are designated by like reference numerals or characters.

### BRIEF DESCRIPTION OF THE DRAWINGS

In the accompanying drawings:

FIG. 1 is a perspective view showing the entire configuration of a mobile audio player system 1;

FIG. 2 is a block diagram showing a circuit configuration of the audio player main unit;

FIG. 3 is external appearance configuration (1) of the remote controller;

FIG. 4 is external appearance configuration (2) of the remote controller;

FIG. 5 is external appearance configuration (3) of the remote controller;

FIG. 6 is a schematic diagram showing a circuit configuration of the remote controller;

FIG. 7 is a schematic diagram showing an example of the liquid crystal display section in an ordinary display mode;

FIG. 8 is a schematic diagram showing a case in which the audio player is attached to a male dress shirt (in ordinary display mode);

FIG. 9 is a schematic diagram showing a display example of the liquid crystal display section in reversal display mode;

FIG. 10 is a schematic diagram showing a case in which the audio player is attached to a female dress shirt (in reversal display mode);

FIG. 11 is a schematic diagram showing a display example (in ordinary display mode) of the volume level;

FIG. 12 is a schematic diagram showing a display example (in reversal display mode) of the volume level;

FIG. 13 is a schematic diagram showing a display example (in ordinary display mode) of a display of functional description of the playback button; and

FIG. 14 is a schematic diagram showing a display example (in reversal display mode) of a display of functional description of the playback button.

### DETAILED DESCRIPTION OF THE EMBODIMENT

Preferred embodiments of this invention will be described with reference to the accompanying drawings:

(1) Configuration of Mobile Audio Player

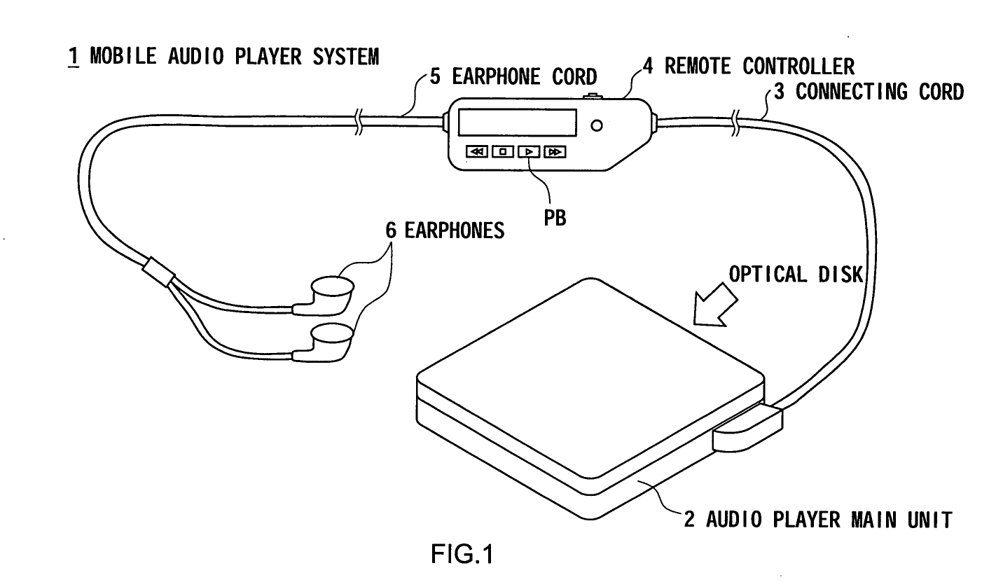

FIG. 1 is a perspective view showing the entire configuration of a mobile audio player system 1 including an audio player main unit 2 having roughly the size of an optical disk (not shown); a remote controller 4 connected to the audio player main unit 2 through a connecting cord 3; and earphones 6 connected to the remote controller 4 through an earphone cord 5.

This mobile audio player system 1 is configured in a manner that a playback signal such as music data recorded on an optical disk is readout for playback, for example, when a playback button PB on a surface of a remote controller 4 is pressed down with the optical disk inserted in the audio player main unit 2, so that music corresponding to the playback signal is outputted from the earphones 6.

(1-1) Configuration of Mobile Audio Player Main Unit

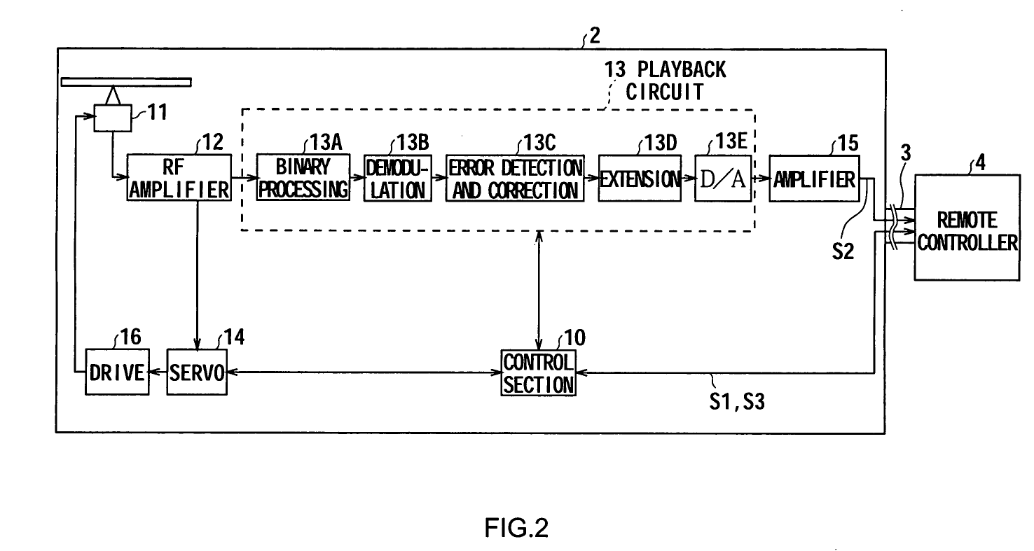

FIG. 2 is a block diagram showing a circuit configuration of the audio player main unit 2 of the mobile audio player system 1. The audio player main unit 2 is so configured that a control section 10 integrally performs total control with an operation signal S1 supplied from the remote controller 4 according to the operation of the remote controller 4, and irradiates light beams from a semiconductor laser of an optical pickup 11 to a signal recording surface of the optical disk rotated through a spindle motor (not shown).

The optical pickup 11 detects the returned light beam reflected on the signal recording surface of the optical disk with a light detector and transmits resulting detected signal therefrom to a RF amplifier 12.

The RF amplifier 12 generates an RF signal, a focusing error signal and a tracking error signal on the basis of the detected signal from the optical pickup 11, and supplies the generated RF signal to a playback circuit 13 as well as the generated focusing error signal and tracking error signal to a servo circuit 14.

The playback circuit 13 includes a binary circuit 13A, a demodulator circuit 13B, an error detection and correction circuit 13C, an extension circuit 13D, and a digital/analog conversion circuit 13E. The binary circuit 13A performs binary processing for the RF signal supplied from the RM amplifier 12, and resulting binary data are transmitted to the demodulator circuit 13B.

The demodulator circuit 13B performs demodulation for the binary data supplied from the binary circuit 13A to obtain the demodulated data and to transmit the data to the error detection and correction circuit 13C.

The error detection and correction circuit 13C performs error detection and correction for detecting and correcting a code error for the demodulated data to transmit resulting error-corrected data to the extension circuit 13D.

The extension circuit 13D performs extension for the error-corrected data to obtain the extended data and to transmit the data to the digital/analog conversion circuit 13E.

The digital/analog conversion circuit 13E performs digital/analog conversion for the extended data to obtain a playback signal S2.

The playback signal S2 obtained by the playback circuit 13 in this way, after being amplified by an amplifier 15, is transmitted to the remote controller 4 through the connecting cord 3.

The servo circuit 14 generates the focusing servo signal and the tracking servo signal in accordance with the focusing error signal and the tracking error signal supplied from the RF amplifier 12, and transmits these signals to a drive circuit 16.

The drive circuit 16 is so configured that focusing and tracking operations of the optical pickup are controlled in accordance with the focusing servo signal and the tracking servo signal supplied from the servo circuit 14.

The control section 10 not only integrally controls the whole audio player main unit 2 in accordance with the operation signal S1 supplied from the remote controller 4, but also transmits a control signal S3 in accordance with the operation signal S1 to the remote controller 4, thus controlling the remote controller 4.

(1-2) Configuration of Remote Controller

(1-2-1) External Appearance Configuration of Remote Controller

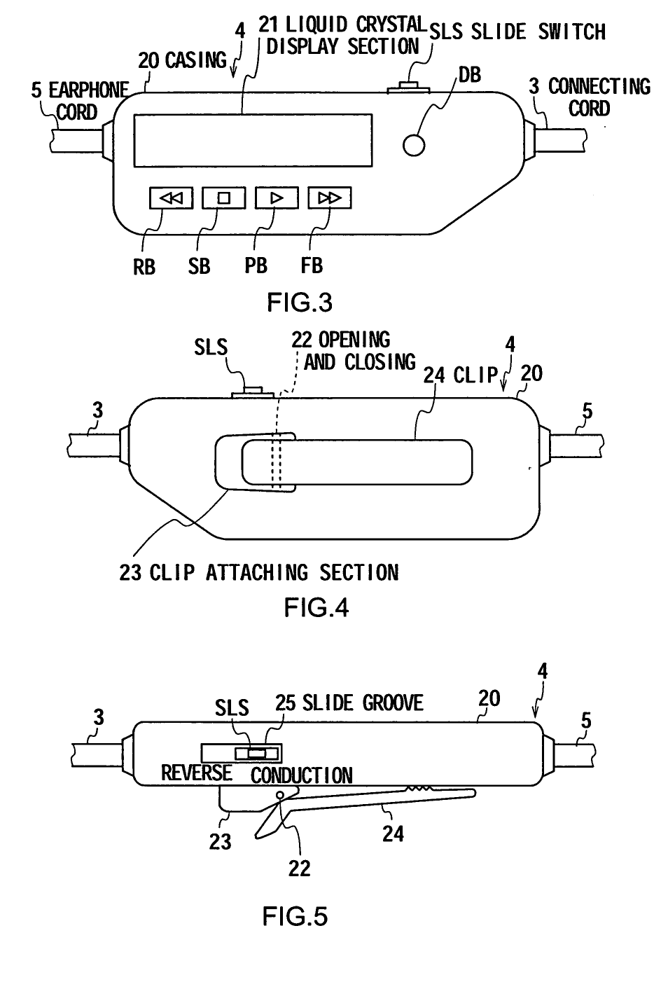

FIGS. 3 to 5 are external appearance configurations of the remote controller 4. The remote controller 4 has a horizontally long flat rectangular casing 20. The earphone cord 5 is connected to one end of the casing 20 and the connecting cord 3 is connected to the other end.

In the center of the surface of the casing 20, a liquid crystal display section 21 consisting of a horizontally long liquid crystal panel is provided along the lengthwise direction of the casing 20.

The liquid crystal display section 21 is of small type which is capable of displaying information of one line of a dozen or so characters. The information not being displayed at a time, such as information of more than a dozen characters, are all displayed by scrolling to one end side from the other end side of the liquid crystal display section 21.

In the vicinity of the liquid crystal display section 21, four operation buttons for playback: a fast-rewind button RB, a stop button SB, a playback button and a fast-forward button FB are provided in a single row along the lengthwise direction of the liquid crystal display section 21. The audio player main unit 2 plays back music data recorded on the optical disk according to the operation of the operation button for playback.

In the vicinity of the liquid crystal display section 21, there is provided a displayed-contents switching button DB for switching contents displayed on the liquid crystal display section 21. Each time the displayed-contents switching button DB is pressed down, the contents displayed on the liquid crystal display section 21, for example, a display of character information such as a song title and an artist name recorded in Table of Contents (TOC) area, a display of the track number and elapsed time of the music data being played back, a display of a volume level and a display of a functional description of the operation button for playback, sequentially change one after another.

On the reverse face of the casing 20, a clip attaching section 23 having an opening and closing pivot 22 which is parallel to the reverse side and perpendicular to the longitudinal direction of the casing 20 is provided at the other end. On the clip attaching section 23, a clip 24 extending to one end side from the other end side of the reverse face through the opening and closing pivot 22 is rotatably attached in such a direction that it is pressed against the reverse face and in such a direction that it is separately opened from the reverse face, and is forced to the reverse face side by a forcing member (not shown) within the clip attaching section 23.

As a result, the casing 20 is structured so as to be latched by sandwiching a dress-shirt pocket or the like from one end side of the casing 20 (a side on which the earphone cord 5 is connected) by the clip 24 provided on the reverse face.

On an outer-periphery surface of the casing 20, there is a slide switch SLS provided along a slide groove 25. When the slide switch SLS is slid to one end side of the slide groove 25, a display mode of the liquid crystal display section 21 is transited to an ordinary display mode described below and, when the slide switch is slid to the other end side, the display mode is transited to a reversal display mode described blow.

(1-2-2) Circuit Configuration of Remote Controller

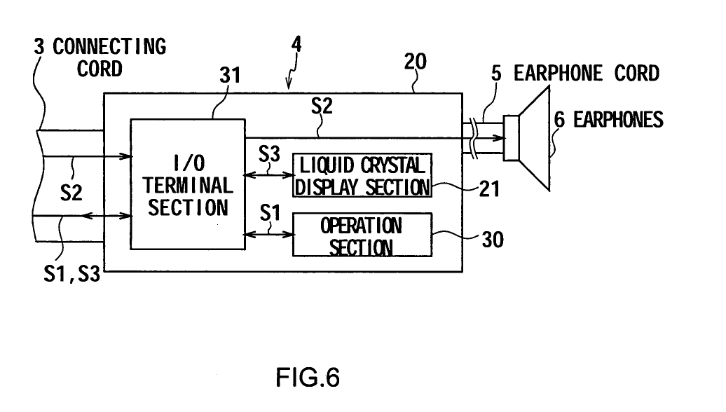

FIG. 6 is a schematic diagram showing a circuit configuration of the remote controller 4. The remote controller 4, when an operation section 30 including the displayed-contents switching button DB, the fast-rewind button RB, the stop button SB, the playback button PB, the fast-forward button FB, and a slide switch SLS is operated, the operation section 30 recognizes the operation to transmit the operation signal S1 corresponding to the operated button to an I/O terminal section 31.

The I/O terminal section 31 transmits the operation signal S1 to the control section 10 of the audio player main unit 2 through the connecting cord 3, so that the remote controller 4 transmits the operation statuses of the respective buttons and the switch as the operation signal S1 to the control section 10 of the audio player main unit 2 to remote-control the audio player main unit 2.

The remote controller 4 inputs the control signal S3 supplied from the control section 10 into the I/O terminal section 31 in accordance with the transmitted operation signal S1 and transmits the control signal S3 from the I/O terminal section 31 to the liquid crystal display section 21. The liquid crystal display section 21 is structured so as to be driven in accordance with the control signal S3.

The remote controller 4 inputs the playback signal S2 supplied from the amplifier 15 of the audio player main unit 2 into the I/O terminal section 31. The playback signal S2 is transmitted into the earphones 6 from the I/O terminal section 31 through the earphone cord 5. Music in accordance with the playback signal S2 is outputted from the earphones 6.

The remote controller 4 is structured so as to remote-control the audio player main unit 2 through the operation section 30, drive the liquid crystal display section 21 in accordance with the control signal S3 from the audio player main unit 2 and to output the playback signal S2 supplied from the audio player main unit 2 from the earphones 6 through the earphone cord 5.

(1-3) Display Mode Switching Function

The mobile audio player system 1 in an embodiment of the present invention includes a display mode switching function for switching a display mode of the liquid crystal display section 21 from the ordinary display mode to the reversal display mode and vice versa. The ordinary display mode and the reversal display mode in the display mode switching function are described below.

(1-3-1) Ordinary Display Mode

The control section 10 of the audio player main unit 2, when the slide switch SLS recognizes that the slide switch SLS has been slid to one end side of the slide groove 25 with the operation signal S1 from the remote controller 4, transmits the control signal S3 for switching a display mode of the liquid crystal display section 21 to the ordinary display mode to the remote controller 4 to drive the liquid crystal display section 21 in the ordinary display mode.

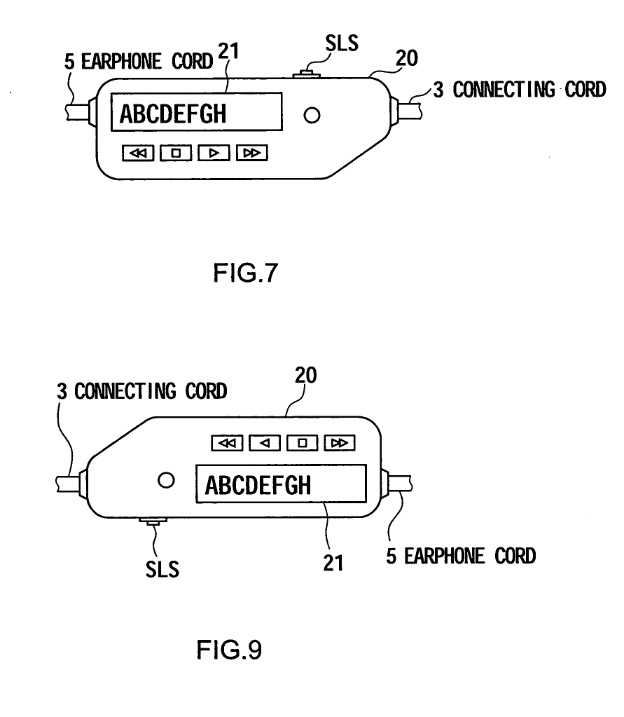

In the liquid crystal display section 21 placed in an ordinary display mode, as shown in FIG. 7, a display direction of displayed characters thereon is set so that a direction of the displayed characters may be proper when a user views the liquid crystal display section 21 from a direction in which one end side of the casing 20 (a side to which the earphone cord 5 is connected) is left-handed and the other end side (a side to which the connecting cord is connected) is right-handed.

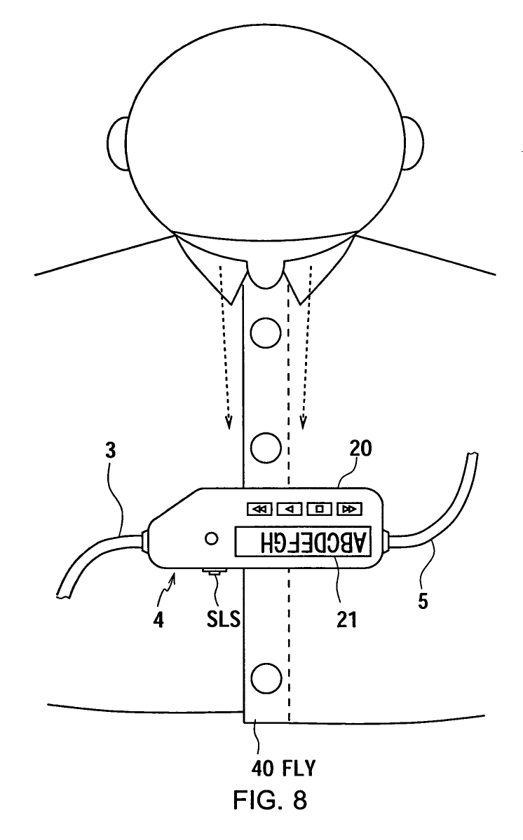

As such a situation in which one end side of the casing 20 is left-handed and the other end side is right-handed when viewed from a user, as shown in FIG. 8, for example, there is a case in which the user hooks the remote controller 4 from a fly 40 of a male dress-shirt he wears.

Namely, in the case that a pocket 40 for a male dress-shirt on the left-handed side of a wearer (a user) is pinched for latching by the clip 24 from one end side of the casing 20, one end side of the casing 20 is left-handed and the other end side is right-handed when the user views the liquid crystal display section 21 of the casing 20.

In such a situation, the user selects the ordinary display mode by sliding the slide switch SLS to one side, so that characters in an exact direction can be viewed through the liquid crystal display section 21.

(1-3-2) Reversal Display Mode

The control section 10 of the audio player main unit 2, when it recognizes that the slide switch SLS has been slit to the other end side of the slide groove 25 with the operation signal S1 from the remote controller 4, transmits the control signal S3 for switching a display mode of the liquid crystal display section 21 to the reversal display mode to the remote controller 4 to drive the liquid crystal display section 21 in the reversal display mode.

In the liquid crystal display section 21 placed in a reversal display mode, as shown in FIG. 9, a display direction of displayed characters thereon is set so that a direction of the displayed characters may be proper when a user views the liquid crystal display section 21 from a direction in which one end side of the casing 20 (a side to which the earphone cord 5 is connected) is right-handed and the other end side (a side to which the connecting cord 3 is connected) is left-handed. Namely, in the reversal display mode, the display direction of characters in the ordinary display mode is reversed.

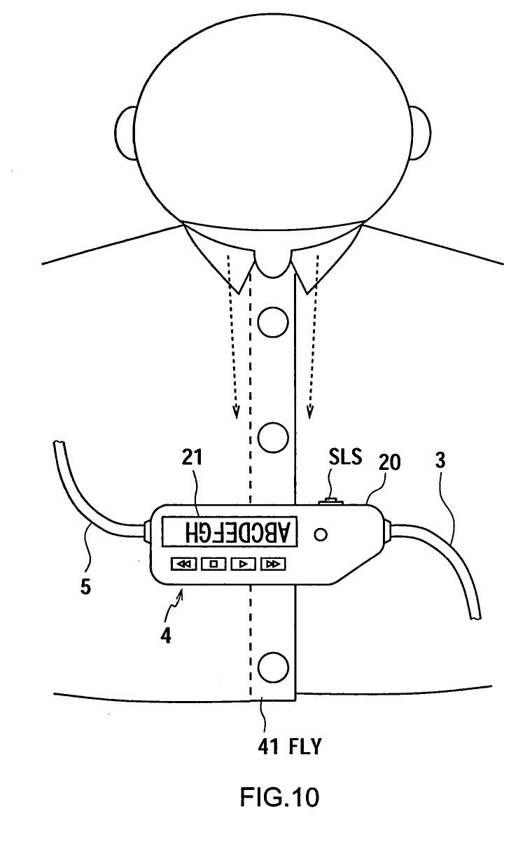

As such a situation in which one end side of the casing 20 is right-handed and the other end side is left-handed when viewed from a user, as shown in FIG. 10, for example, there is a case in which the user hooks the remote controller 4 from a pocket 41 of a female dress-shirt she wears.

Namely, in the case that a pocket 41 for a female dress-shirt on the right-handed side of a wearer (a user) is sandwiched for latching by the clip 24 from one end side of the casing 20, one end side of the casing 20 is right-handed and the other end side is left-handed when the user views the liquid crystal display section 21 of the casing 20.

In such a situation, the user selects the reversal display mode by sliding the slide switch SLS to the other side, so that characters in an exact direction can be viewed through the liquid crystal display section 21.

(1-4) Operation and Effect

The mobile audio player system 1 in the above configuration transits the display mode of the liquid crystal display section 21 from the ordinary display mode to the reversal display mode and vice versa according to the slide operation of the slide switch SLS provided on the casing 20 of the remote controller 4.

The control section 10 of the audio player main unit 2 controls the liquid crystal display section 21 so that a display direction of characters on the liquid crystal display section 21 may be reversed in the ordinary display mode or the reversal display mode.

Thereby, the mobile audio player system 1 can switch a display direction of contents on the liquid crystal display section 21 according to the slide operation of the slide switch SLS by the user.

With the above configuration, the mobile audio player system 1 switches a display direction of contents on the liquid crystal display section 21 according to slide operation of the slide switch SLS, so that the display direction can be prevented from being switched despite the intention of a user, thus the display direction of contents on the liquid crystal display section 21 can be switched more appropriately than an old one.

### (2) Other Preferred Embodiments

One embodiment of the present invention describes a case in which the present invention is applied to the mobile audio player system 1 as an electronic device equipped with the remote controller 4 as a remote control device and an operation device. It is understood that the scope of the present invention is not limited to a particular arrangement of the mobile audio player system 1. The present invention can be widely applied to various types of electronic devices such as digital cameras, mobile phones and game machines with display devices and remote controllers for the electronic devices.

The above embodiment demonstrates a case in which the display direction of contents on the liquid crystal display section 21 is reversed, but the present invention is not limited to such a case. The display direction may be switched in a plurality of directions such as 90-degree rotation.

The above embodiment demonstrates a case in which a display direction of characters on the liquid crystal display section 21 is reversed, but the present invention is not limited to such a case. An increase/decrease direction of a volume level displayed on the liquid crystal display section 21 may be rotated.

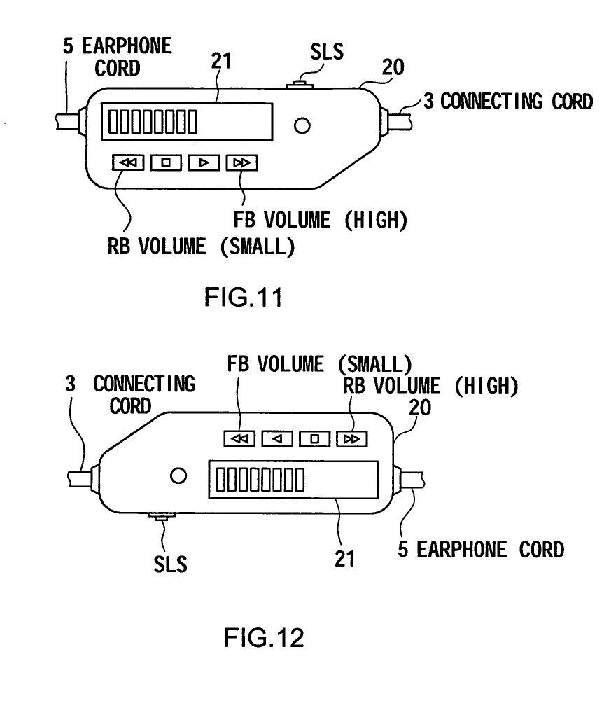

As shown in FIGS. 11 and 12, for example, the liquid crystal display section 21 displays a volume level adjustment bar as a volume level display indicator visually indicating an increase/decrease in volume level. In the ordinary display mode, a display direction of the volume level adjustment bar is set so that the volume level adjustment bar may extend from one end side to the other end side of the liquid crystal display section 21 and the volume level adjustment bar may contract in the reverse direction. In this case, the fast-forward button FB may be allotted with a function of extending the volume level adjustment bar to increase volume level. The fast-rewind button RB may be allotted with a function of contracting the volume level adjustment bar to decrease volume level.

On the other hand, in the reversal display mode, a display direction of the volume level adjustment bar is set so that the volume level adjustment bar may extend from the other end side to one end side of the liquid crystal display section 21 and the volume level adjustment bar may contract in the reverse direction. Namely, the reversal display mode causes a reverse condition of the volume level adjustment bar in the ordinary display mode so that the volume level adjustment bar may contract. In this case, The fast-rewind button RB may be allotted with a function of extending the volume level adjustment bar to increase volume level. The fast-forward button FB may be allotted with a function of contracting the volume level adjustment bar to decrease volume level.

The increase/decrease direction of the volume level displayed on the liquid crystal display section 21 is reversed in this way, and the function of adjusting the volume level according to the reversal is provided for the prescribed button, thus unifying operability and further improving convenience without restricting such a direction as to use of the remote controller 4.

In the above embodiment, switching only a display direction of characters on the liquid crystal display section 21 is described, but the present invention is not limited to such a case. The display direction of the functional description of the respective operation buttons for playback: the fast-rewind button RB, the stop button SB, the playback button PB and the fast-forward button FB displayed on the liquid crystal display section 21 may be switched, and the allotment of the function may be switched for the respective operation buttons for playback: the fast-rewind button RB, the stop button SB, the playback button PB and the fast-forward button FB.

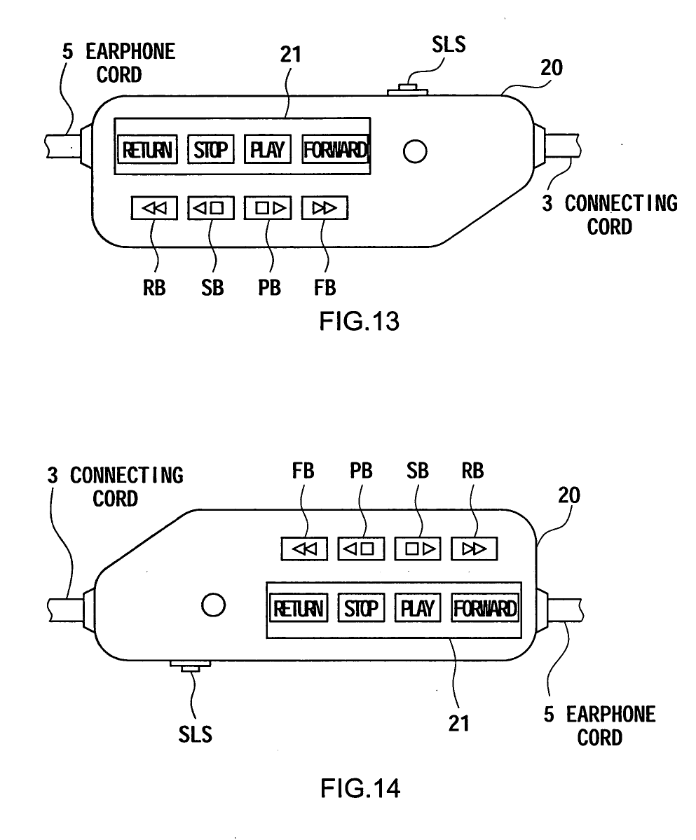

In this case, as shown in FIG. 13, for example, the liquid crystal display section 21 in the ordinary display mode displays functional descriptions: fast-rewind, stop, playback and fast-forward of the respective operation buttons for playback at a display positions corresponding to the positions of four operation buttons for playback: the fast-rewind button RB, the stop button SB, replay button and fast-forward button. This enables a user to view what type of functions the respective operation buttons have through the liquid crystal display section 21.

In the reversal display mode, as shown in FIG. 14, the functions of the fast-rewind button RB, the stop button SB, the playback button PB and the fast-forward button FB are respectively switched to fast-forward, playback, stop and fast-rewind, according to which, the display direction of functional description of the respective operation buttons for playback displayed on the liquid crystal display section 21 is reversed, thus unifying operability and further improving convenience without restricting such a direction as to use of the remote controller 4.

The above embodiment shows that the information not to be displayed on the liquid crystal display section 21 at a time are all displayed by scrolling from the other end to one end of the liquid crystal display section 21, but the present invention is not limited to such a case. By scrolling from the other end side to one end of the liquid crystal display section 21 in the ordinary display mode and, in the reversal display mode, scrolling from one end side to the other end side, scrolling direction may be switched between the ordinary display mode and the reversal display mode.

The above embodiment demonstrates that the liquid crystal display section 21 consisting of a liquid crystal panel is used, but the present invention is not limited to such a case and various types of display devices such as a plasma panel or an Electro Luminescence (EL) may be used in place of the liquid crystal panel.

The above embodiment describes a case in which the control section 10 of the audio player main unit 2 controls the liquid crystal display section 21 of the remote controller 4, but the present invention is not limited to such a case. A control section of controlling the liquid crystal display section 21 may be provided within the remote controller 4 so that the control section can control the liquid crystal display section 21.

The above embodiment describes a case in which switching is performed between the ordinary display mode and the reversal display mode by sliding the slide switch SLS to one end side or the other end side of the slide groove 25, but the present invention is not limited to such a case. For example, a lock type of push button capable of retaining a pressed-down condition may be used in place of the slide switch SLS so that the push button can switches the mode. If it is a type for a user to operate by himself/herself, any of a variety of operation devices may be used.

The above embodiment describes a case in which the slide switch SLS is provided on the outer-periphery surface of the casing 20, but the present invention is not limited to such a case. The slide switch SLS may be provided on one surface of the casing 20 or one surface of the audio player main unit 2.

The above embodiment describes a case in which the remote controller 4 and the audio player main unit 2 are constituted of the liquid crystal display section 21 as a display means, the slide switch SLS as a switching means, a fast-rewind button RB as an operation means, the stop button SB, the playback button PB and the fast-forward button FB, the control section 10 as a control means and the playback circuit 13 as a playback means. The present invention is not limited to such a case. The remote controller 4 and the audio player main unit 2 may be constituted of other types of components.

The present invention can be widely applied to remote controllers and electronic devices equipped with a display respectively.

While there has been described in connection with the preferred embodiments of the invention, it will be obvious to those skilled in the art that various changes and modifications may be aimed, therefore, to cover in the appended claims all such changes and modifications as fall within the true spirit and scope of the invention.

1. A remote control device comprising:
a display means;
switching means for switching a display direction of contents displayed on the display means; and
operation means for remote-controlling a main unit thereof,
wherein the display means switches the display direction of the displayed contents according to operation of the switching means.

2. The remote control device according to claim 1, wherein the display means displays the operation contents of the operation means as a contents representation and switches a display direction of the operation contents displayed according to the operation of the switching means.

3. The remote control device according to claim 2, wherein the operation means comprises a plurality of operation elements and switches operation contents of the plurality of operation elements according to the operation of the switching means.

4. The remote control device according to claim 1, wherein the main unit thereof includes playback means for playing back data, and
the display means indicates an output level display element to be expanded and contracted in a prescribed direction according to an increase and decrease of an output level of the data as the contents and switches an expanding and contracting direction of the output level display element to be displayed according to the operation of the switching means.

5. The remote control device according to claim 1, wherein the display means scrolls the contents to be displayed in a prescribed direction if the contents are difficult to display so that whole contents are displayed at one time, and switches a scroll direction of the contents to be displayed according to the operation of the switching means.

6. An electronic device comprising:
display means;
switching means for switching a direction of contents to be displayed on the display means;
operation means for operating a main unit thereof; and
control means for executing control over switching of a display direction of contents on the display means according to the operation of the switching means.

7. The electronic device according to claim 6, wherein the display means displays operation contents of the operation means as the contents and the control means switches the display of the operation contents to be displayed according to the operation of the switching means.

8. The electronic device according to claim 7, wherein the operation means comprises a plurality of operation elements and switches operation contents of the plurality of operation elements according to the operation of the switching means.

9. The electronic device according to claim 6, wherein the main unit includes playback means for playing back data,
the display means displays an output level display element expanding or contracting in a prescribed direction according to an increase or decrease in an output level of the data as the contents, and
the control means switches an expanding and contracting direction of an output level display element to be displayed according to the operation of the switching means.

10. The electronic device according to claim 6, wherein the control means scrolls the contents to be displayed in a prescribed direction if the contents are difficult to display so that whole contents are displayed at one time, and switches a scroll direction of the contents to be displayed according to the operation of the switching means.
